(19) United States
(12) Patent Application Publication
(10) Pub. No.: US 2020/0222271 A1
(43) Pub. Date: Jul. 16, 2020

(54) Therapeutic Device

(71) Applicant: Muscle Compression Therapies Pty Ltd, Anstead (AU)

(72) Inventor: Phillip Forostenko, Anstead (AU)

(73) Assignee: Muscle Compression Therapies Pty Ltd, Anstead (AU)

(21) Appl. No.: 16/648,499

(22) PCT Filed: Sep. 18, 2018
(86) PCT No.: PCT/AU2018/051022

§ 371 Date: Mar. 18, 2020

(30) Foreign Application Priority Data
Sep. 18, 2017 (AU) 2017903792

(51) Int. Cl. A61H 15/00; A61H 1/00

(52) U.S. Cl. CPC A61H 15/0092; A61H 1/008; A61H 2015/005; A61H 2201/0134; A61H 2201/1645; A61H 2205/106; A61H 2201/1609; A61H 2201/1685; A61H 2205/026; A61H 2205/04; A61H 2201/0192

(57) ABSTRACT

A therapeutic device including: a substantially U-shaped frame member having an inconstant cross section and a longitudinal axis substantially bisecting the U; a plurality of protuberances in spaced relation along the inner face of the frame member and arranged in opposed pairs such that the protuberances of each pair each extends towards the other; a handle on each end of the frame member, each handle having an engagement face extending substantially laterally to the longitudinal axis; and locking means for locking the handles at a desired spacing from one another.

### FIELD OF INVENTION

THIS INVENTION relates to a therapeutic device. The present invention is primarily directed a therapeutic device for application of pressure to selected locations on the body. The invention has particular application to application of static pressure, but may also be used for application non-static pressure, which may be taken to mean a form of massage.

### BACKGROUND ART

Therapeutic devices are known which may be used to apply a static pressure to the body by a clamping mechanism having inwardly directed protuberances. Such devices are normally formed from flexible plastics materials or the like and have two or more protuberances arranged in opposed pairs to engage with the body at selected locations, one protuberance normally being directly opposite the other. Pressure is applied to the protuberances by closing the clamp, the applied pressure being proportional to the force applied to opposed handles of the clamp. However, such devices are confined to operation as a clamping device only and most such devices have one relative position for the protuberances between the hinge of the clamp and the handles. Such devices are normally formed for use on particular locations on the body. Such devices are commonly dimensioned for use on opposed sides of the upper neck, applying pressure to the upper portions of the sternocleidomastoid muscle, or generally about the area of the mastoid process or power occiput.

Such devices have limited flexure, with the result that they cannot be readily applied to other locations on the body, or a limited to such areas which have the same spatial separation as the opposed sides of the neck. Such devices are prone to failure at the hinge or the protuberances break off, particularly if users attempt to use them on other locations of the body. Breakage can also occur if, when applying pressure on opposed sides of the neck, the user attempts to apply pressure to the superior fibres of the trapezius or apply a forward pressure to the mastoid process or occipital regions of the head. Moreover, for some types of treatment, the user is required to hold the device at the required position for an extended period of time.

In this specification, terms such as horizontal, vertical, upper, lower and such like may be used for convenience only to describe relative positions of elements of the invention in its normal operational orientation or with the user, or the relevant portion of the user's body, in an upright disposition and are not to be construed so as to limit the invention to any particular orientation for either the device or the user.

The present invention aims to provide a therapeutic device which alleviates the problems of prior art devices and/or provide a therapeutic device which has a wider range of uses. Other aims and advantages of the invention may become apparent from the following description.

### DISCLOSURE OF THE INVENTION

With the foregoing in view, the present invention in one aspect resides broadly in a therapeutic device including:
a substantially U-shaped frame member having an inconstant cross section and a longitudinal axis substantially bisecting the U;
a plurality of protuberances in spaced relation along the inner face of the frame member and arranged in opposed pairs such that the protuberances of each pair each extends towards the other;
a handle on each end of the frame member, each handle having an engagement face extending substantially laterally to the longitudinal axis; and
locking means for locking the handles at a desired spacing from one another.

The inconstant cross section is arranged to provide differing degrees of flexibility along the frame member such that the region about the base of the U is relatively more flexible than the remaining portions of the U. For convenience, the base of the U will be referred to as the hinge portion and the portions extending from each end of the hinge portion will be referred to as the arms. The inconstant cross section as herein described affords the manufacture of the frame member to be constructed from a single material as a unitary construction or integral form. The handles, as mentioned previously, extend substantially laterally to the longitudinal axis. That is to say, there is a lateral component to the extension, but preferably, also a forward component, thereby allowing a user to both pull the therapeutic device forward and urge the distal ends of the arms towards each another.

Preferably, the protuberances are provided as removable knobs, pommels or such like, referred to hereinafter as massage balls, the frame member being provided with attachment means for attachment of a pair of massage balls in substantially fixed disposition at a selected location along the inside of the arms, the inside of the arms being generally that portion of each which faces the other. Alternatively, one of the protuberances may be in the form of a pad or the like having a body engagement face for spreading the load across an area of the body such that the other protuberance may be applied to the body of a user as a single-point application of pressure. The pad may be flexible in order to confirm to the shape of that part of the body of the user to which the pad is applied. It will thus be seen that the term “pair” is to be taken to encompass arrangements where the pair is made up of non-identical elements.

The massage balls may be provided in bilobial or multilobial form. That is to say, one or both of the massage balls may have two or more rounded projections oriented for substantially simultaneous engagement with the body of a user. Suitably, the protuberances have a rounded face for engagement with the body of a user and it will be appreciated that the remainder of the form of the protuberances is largely irrelevant, save for the form required for attachment to, and detachment from, the frame member.

Preferably, the frame member is not flat, but follows an undulating profile having a single anticline and a single syncline along the arms to and including the hinge portion. That is to say, the device is curved one way and then the other, preferably is a somewhat flattened S-shape looking side on to the device. The undulating form of the frame member is thus asymmetrical about a transverse plane coincident with the longitudinal axis but substantially symmetrical about a medial plane orthogonal to the transverse plane. The aforementioned longitudinal axis coincides with the transverse plane.

The locking means is preferably a cord, strap or the like connecting the open ends of the U of the frame or the handles together. In a preferred form, the cord is fastened to a take-up means arranged within one of the arms and may be drawn out from the take-up means through an access hole. The cord may be then fastened to a cleat or similar mechanism on the other handle. In a further preferred form, each handle has the take-up means and cord as well as the cleat or similar mechanism whereby two cords may be used to hold the handles together at a predetermined spacing. It is preferred that cord locking means be provided for locking the cord or cords at or near the access hole. Alternatively, the cords are provided with a maximum extent and can be drawn out through the access holes and then secured to the other handle by engagement of one of a plurality of securing means along the distal portion of each of the cords.

In another form, a cord is fixed by one end to one or both of the handles and attachable or fastenable to the other handle at or intermediate the other end to lock the handles at a desired spacing therebetween. For example, the securing means may be in the form of a plurality of regularly spaced knots at least part way along the length of the cord for engagement with a slot or the like in the handle. Alternatively, the slot may be of such form as to engage with the cord by a self ratcheting system or gripping arrangement.

### BRIEF DESCRIPTION OF THE DRAWINGS

In order that the invention may be more readily understood and put into practical effect, two slightly different versions of a preferred embodiment of the present invention will be described with reference to the following drawings, and wherein:

FIG. 1 is an orthographic pictorial of a therapeutic device according to the invention, from the rear, below and left-hand side, shown with balls and other engagement elements attached;

FIG. 2 is a plan view of underside of the therapeutic device of FIG. 1;

FIG. 3 is an orthographic pictorial view of the therapeutic device of FIG. 1 with the balls and other engagement elements removed;

FIG. 4 is a plan view of the therapeutic device of FIG. 3;

FIG. 5 is a plan view of the underside of the therapeutic device of FIG. 3;

FIG. 6 is a rear elevation of the therapeutic device of FIG. 3;

FIG. 7 is a front elevation of the therapeutic device of FIG. 3;

FIG. 8 is a side view of the right-hand side of the therapeutic device of FIG. 3;

FIG. 9 is an orthographic pictorial view of an alternative version of the therapeutic device described with reference to FIGS. 1 to 8 from the rear, below and right-hand side;

FIG. 10 is an orthographic pictorial view of the therapeutic device of FIG. 9 from the front, top and right-hand side;

FIG. 11 is an orthographic plan view of the device of FIG. 9 from below;

FIG. 12 is an orthographic side view of the device of FIG. 9 from the left-hand side;

FIG. 13 is an orthographic pictorial view of part of the therapeutic device of FIG. 9 showing detail of a spherical protuberance;

FIG. 14 is an orthographic pictorial view of part of the therapeutic device of FIG. 9 showing detail of a prolate spherical protuberance;

FIG. 15 is an orthographic pictorial view of part of the therapeutic device of FIG. 9 showing the rear side of the right handle; and

FIG. 16 is an orthographic pictorial view of part of the therapeutic device of FIG. 9 showing the front side of the right handle.

### DETAILED DESCRIPTION OF THE DRAWINGS

In the drawings, reference is made to “front”, “rear”, “top” or “upper”, “bottom” or “lower”, “left”, or “right” in view of a general usage of the invention against the rear of the neck with the handles towards the user's front. It will be appreciated that such terms are merely for the convenience of reference to the relationships and dispositions of the various parts of the device and not to confine the usage of the device to any particular part of the body or to any particular orientation. In the drawings, the reference numerals refer to the same parts in each drawing. However, the reference numerals are not provided in every drawing illustrating such parts in order to avoid cluttering the drawings and to aid clarity of the disclosure. Additionally, several lines appear around or along the body and other elements of the therapeutic device as illustrated even though the body and/or such elements are of unitary construction; the skilled addressee will appreciate that such lines are merely an artefact of the illustrations and are not to be taken as indicating any structural demarcation between adjoining parts.

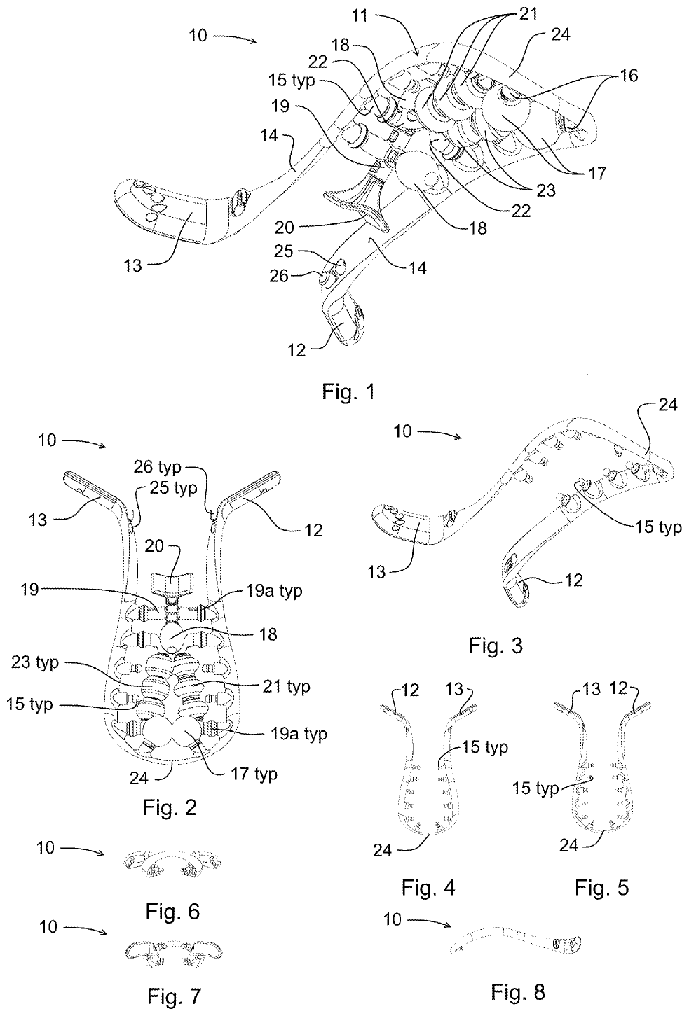

The therapeutic device 10 shown in FIGS. 1 to 8 has a main frame portion 11, referred to hereinafter as the frame, which is generally of a U-shaped configuration, or more particularly, a shape akin to a horseshoe. Two handle portions are provided, each one extending from the ends of the frame, being a right handle 12 and a left handle 13. The handles transition from the main frame portion and are of a unitary construction with the frame, the point at which the frame becomes the handle being somewhat arbitrary, delineated in the drawings by a transitional region at 14. The handles splay outwards such that the frame and handles together in plan view have a shape reminiscent of the capital letter omega of the Greek alphabet, viz: “Ω”.

As indicated above, the terms front and rear of the device are used arbitrarily, the handles being at the front and the base of the U being at the rear, and are splayed outwards to enable the user to push forwards. The device as illustrated in FIGS. 1 and 2 is in a form as would be sold or transported, having optional parts attached as described below.

Six pairs of mounting lugs shown typically at 15 are spaced along the inner side of the main frame portion, the forward five pairs being substantially regularly spaced from one another along the frame and the rear pair 16 being further spaced from the other pairs. The spacing and disposition of the mounting lugs affects their orientation. The forward five pairs are oriented laterally towards the centre of the U whereas the rear pair are oriented to project forwards as well as laterally inwards.

The protuberances herein described are provided in the form of balls or wheels, and the arrangement illustrated in FIGS. 1 and 2 being to show different kinds of protuberances contemplated in both their possible form and possible arrangement, but in particular as the therapeutic device might be sold or stored. Other arrangements would be used for particular applications and other configurations of protuberance other than those illustrated may be used.

Two spherical balls 17 are shown attached to the rear mounting lugs. Two prolate spherical balls 18 are shown attached to an attachment holder 19 extending between the forward most pair of mounting lugs. The attachment holder is arranged as having six projecting arms each at 90° to the adjacent four arms and in line with the remaining arm opposite thereto. A mounting lug is provided at the distil ends of four of the arms and a connecting socket to the remaining two, those arms with the connecting sockets being in line to extend between the opposed mounting lugs. Locking ring 19a locks the connecting sockets firmly onto the mounting lugs to prevent accidental detachment, the attachment holder also holding the remainder of the therapeutic device in fixed shape against deformation whilst being stored or transported.

A pad 20 is mounted to one of the mounting lugs of the attachment holder adjacent one of the prolate spherical balls and in line with the other mounting lug. The remaining mounting lug of the attachment holder is vacant in the illustration shown and is not visible in FIG. 1 or 2. The pad may be used instead of one of the balls, particularly for application of the device to the calf muscle at the rear of a user's leg, the pad being applied to the shin and spreading the load across most of the extend of the pad.

Three oblate spheroid wheels 21 are shown mounted to a mounting bar arrangement 22 on the left-hand arm of the therapeutic device and in a corresponding fashion, three flat-faced wheels 23 are mounted on another mounting bar arrangement 22, one of the wheels being hidden from view behind a spherical ball in FIG. 1. The mounting bar arrangement is the same for the oblate spheroid wheels and the wheels, and each includes two elbow sections, one attached forward most mounting lug and the other attached to the rear most mounting lug, the second and third mounting lugs being unoccupied in the example shown in FIGS. 1 and 2. The massage wheels, whether in the form of an oblate spheroid or flat faced, are able to rotate about their respective centres, thereby permitting use on the body where rolling movement is desirable, such as, but not limited to, limbs.

In use, only one pair of massage balls may be installed, the user normally selecting identical massage balls, but, of course, being able to select non-matching massage balls if desired, including, the other types of protuberance as described herein. The massage balls are connected to the mounting lugs by a snap-fit arrangement, being free to rotate about the axis of each mounting lug, though such rotation is not necessary for the function of the therapeutic device according to the invention.

The frame also has a hinge region at 24 extending around or part-way around the rear portion thereof. The hinge portion is facilitated by the inconstant cross section of the frame mentioned previously in this specification, the hinge portion being thinner in the relevant dimension than the remainder of the frame. It will be appreciated that the frame is constructed from a rigid, but resiliently flexible material.

Each arm also includes a cord or rope aperture 25 open to the inner side or face of the arms for receiving a cord therethrough, the cord aperture being forward of the mounting lugs and close to the transition from the distal end of the respective arm and proximal end of the respective handle. The cord may be pushed into a cavity provided in the arm and/or handle having capacity sufficient to receive same. Alternatively, the cord may be coiled on a spring loaded winder or retractor inside the handle or arm and has a length in excess of the distance between the handles when unstressed. The winder or retractor is able therefore to retract the cord through the cord aperture, being wound onto the winder or retracted lineally by way of a stretchable element or the like. A lock and release button 26 is also provided, biased to lock onto the cord and prevent its extraction or retraction from the storage cavity or if it is left loose, but, when pressed, releasing the cord so that it is free to move into our out from the cavity.

Each handle has a cord locking cavity 27 generally in the forward and transverse directions, and sized to pass the cord therethrough. A serrated channel or slot extends generally outward from the cavity towards the end of the handle. A plurality of serrations shown typically at 28 are provided along the sides of the slot, the serrations being sloped such that a tensile force on the cord extending between the handles urges the rope further, that is deeper, into the slot. The side walls are preferably wider at the outer edges so that as the rope or cord is urged deeper into the slot—the “locking slot”, it is gripped more tightly by the serrations.

Referring in particular to the side views of FIGS. 8 and 12, the frame has a pronounced curvature convex upwards, referred to as an anticline portion 29 along the rear portion of the frame and a less pronounced curvature concave upwards, referred to as a syncline portion 30 along the forward portion of the frame. Such an arrangement permits use of the device further down the trapezius than prior devices and also facilitates use of the device on other parts of the body.

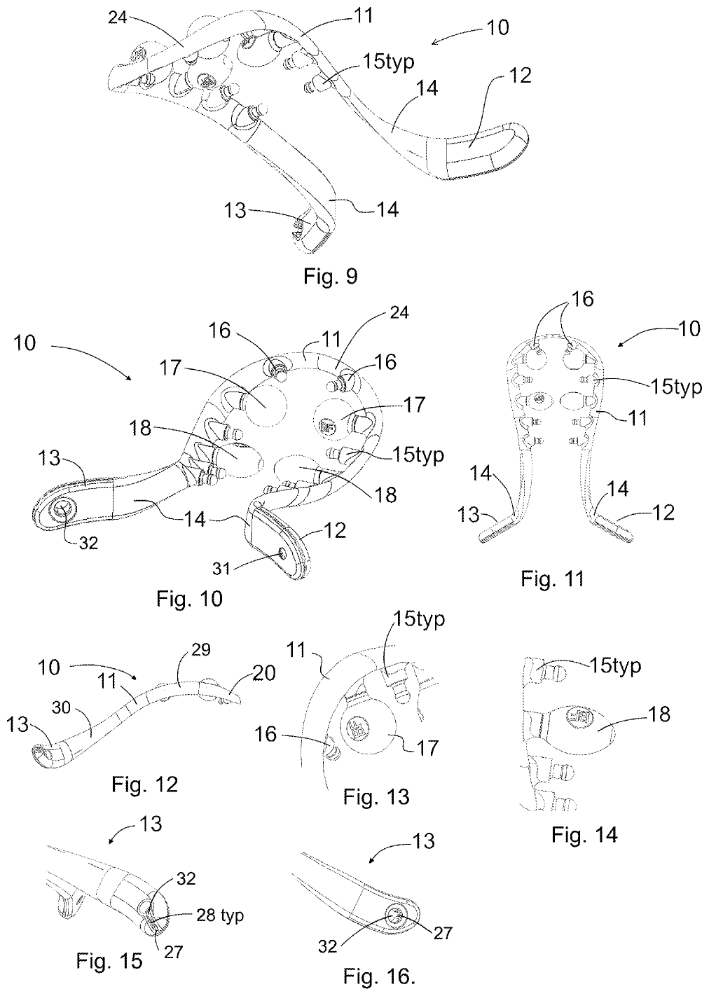

The therapeutic device 10 shown in FIGS. 9 to 16 is the same in nearly all respect as that shown in FIGS. 1 to 8. As indicated above, the terms front and rear of the device are used arbitrarily, the handles being at the front and the base of the U being at the rear, and are splayed outwards to enable the user to push forwards. The same reference numerals are used for the same parts or elements.

The protuberances herein described are provided by either spherical massage balls 17 or prolate spherical balls 18, both types being illustrated as installed on the mounting lugs fifth and third from the front respectively in FIGS. 9 to 11.

The right handle also includes a cord or rope attachment 31 for fixedly attaching a cord thereto, the cord having a length in excess of the distance between the handles when unstressed. The left handle has an aperture 32 penetrating therethrough generally in the forward and transverse directions, and sized to pass the cord therethrough. A serrated channel or slot extends generally outward from the aperture towards the end of the handle in a similar arrangement to that illustrated in FIGS. 1 to 8.

It will be seen that the main difference between the two versions, that is, that shown in FIGS. 1 to 8 as compared to that shown in FIGS. 9 to 16, is the provision of alternative arrangements for the cord, the former being two cords retractable and extending from the transition from the arm to the handle, and the latter being a single cord fixed to one of the handles and being attachable to the other one of the handles.

The therapeutic device according to the invention may be used by selecting one point location or two opposed point locations requiring constant or inconstant application of pressure. Either a prolate spherical or spherical ball is attached to the or each mounting lug at the appropriate position along the length of the frame. For the application of single-point pressure, the pad fitting is attached to the opposing mounting lug. For the pressure to opposing points, the protuberance element is attached to opposing mounting lugs.

Once the pressure points have been located and the appropriate amount of pressure determined, the cord may be secured in the locking slot so that the pressure may be maintained without having to apply pressure to the handles. If desired, the device may be moved about, particularly if the applied pressure is not too great, such that the device may also find at least limited use as an aid in massage therapies. The orientation of the handles also permits the user to adopt a more natural or restful use of the device when using protuberances mounted to the rear pair of mounting lugs, in particular, when applying a pressure to parts of the upper strands of the trapezius or the occipital process at the back of the head.

The wheels are provided as an assembly and are also fixed with the aid of a locking ring similar to that described with reference to the attachment holder.

Although the protuberances have been described as being mounted to the mounting lugs along their respective axes of circular symmetry, the invention is not necessarily limited to such an arrangement. Oblate spherical balls and other shapes are encompassed in the concept of the invention. What is contemplated is a curvilinear bearing face in distal disposition with respect to the mounting lug, and it is preferred that the point at which each protuberance is most distal is in substantial alignment with the axis of the mounting lug to which it is mounted.

Moreover, although a pair of identical balls is normally used for most applications, balls having different forms may be used, or one ball may be matched with more than one on the other side of the device. For application to the neck area, for example, a pair of balls of one type may be mounted to the rear mounting lugs and a pair of balls of another type may be mounted to opposed mounting lugs along the arms of the device and, once locked in place by the cord or cords, the device is relatively stable in its position on the neck. It will be appreciated that different attachments may be mixed and matched to achieve desired results in the use of the therapeutic device of the present invention.

Although the invention has been described with reference to a specific example, it will be appreciated by those skilled in the art that the invention may be embodied in other forms within the broad scope and ambit of the invention as herein set forth and defined by the following claims.

What is claimed:

1. A therapeutic device including:
a substantially U-shaped frame member having an inconstant cross section and a longitudinal axis substantially bisecting the U;
a plurality of protuberances in spaced relation along the inner face of the frame member and arranged in pairs on opposite sides of the U such that the protuberances of each pair each extends towards the other;
a handle on each end of the frame member, each handle having an engagement face extending substantially laterally to the longitudinal axis; and
locking means for locking the handles at a desired spacing from one another.

2. The therapeutic device according to claim 1, wherein the protuberances are provided as removable knobs, pommels or such like, referred to hereinafter as massage balls, the frame member being provided with attachment means for attachment of a pair of massage balls in substantially fixed disposition at a selected location along the inside of the arms, the inside of the arms being generally that portion of each which faces the other.

3. The therapeutic device according to claim 1, wherein one of the protuberances is in the form of a pad or the like having a body engagement face for spreading the load across an area of the body such that the other protuberance may be applied to the body of a user as a single-point application of pressure.

4. The therapeutic device according to claim 1, wherein the massage balls are provided in multilobial form.

5. The therapeutic device according to claim 1, wherein the frame member follows an undulating profile having a single anticline and a single syncline along the arms to and including the hinge portion.

6. The therapeutic device according to claim 1, wherein the locking means is a cord connecting the open ends of the U of the frame or the handles together.

7. The therapeutic device according to claim 6, wherein the cord is fastened to a take-up means arranged within one of the arms or handles and may be drawn out from the take-up means through an access hole.

8. The therapeutic device according to claim 7, wherein the cord, take-up means and locking means are provided on both arms and/or handles.

9. The therapeutic device according to claim 5, wherein the protuberances are provided as removable knobs, pommels or such like, referred to hereinafter as massage balls, the frame member being provided with attachment means for attachment of a pair of massage balls in substantially fixed disposition at a selected location along the inside of the arms, the inside of the arms being generally that portion of each which faces the other.

10. The therapeutic device according to claim 9, wherein the massage balls are provided in multilobial form.

11. The therapeutic device according to claim 5, wherein one of the protuberances is in the form of a pad or the like having a body engagement face for spreading the load across an area of the body such that the other protuberance may be applied to the body of a user as a single-point application of pressure.

12. The therapeutic device according to claim 5, wherein the locking means is a cord connecting the open ends of the U of the frame or the handles together.

13. The therapeutic device according to claim 12, wherein the cord is fastened to a take-up means arranged within one of the arms or handles and may be drawn out from the take-up means through an access hole.

14. The therapeutic device according to claim 13, wherein the cord, take-up means and locking means are provided on both arms and/or handles.
